(19) United States
(12) Patent Application Publication
(10) Pub. No.: US 2025/0145864 A1
(43) Pub. Date: May 8, 2025

(54) Laminates and Method of Manufacture Thereof

(71) Applicant: Linermist Limited, Great Dunmow, Essex (GB)

(72) Inventors: Bruce Michael Drew, Great Dunmow, Essex (GB); Michael John Cooper, Colchester, Essex (GB); David Nicholas Edwards, Atlanta, GA (US)

(21) Appl. No.: 18/837,684

(22) PCT Filed: Jan. 11, 2024
(86) PCT No.: PCT/GB2024/050062

§ 371 Date: Aug. 12, 2024

(30) Foreign Application Priority Data
Jan. 13, 2023 (GB) 2300539.0

(51) Int. Cl. C09J 7/29; C09J 7/38

(52) U.S. Cl. CPC C09J 7/29; C09J 7/38; C09J 2203/334; C09J 2301/302

(57) ABSTRACT

A self-adhesive laminate material and method of manufacture thereof in which a water-soluble coating applied to a print-receptive coating on a first side of the material is transferred to an adhesive on a second side of the material. When the material is rolled up, the water-soluble coating transfers from the first side to the second side, thereby offering protection to the adhesive.

### DESCRIPTION

This invention relates to self-adhesive laminates and method of manufacture thereof. The invention has particular, but not exclusive, application to laminates suitable for labelling or decoration or graphic signs or the like.

Most laminates used for labelling or decoration or graphic signs have an adhesive backing and a release liner which protects the adhesive during, for example, cutting, printing and/or handling. The liner typically has a release coating, such as silicone, which allows the liner to be removed from the adhesive prior to application of the laminate to a surface.

Such laminates are typically made in roll form which are shipped, printed and die cut before being applied to an article to be labelled or decorated, or converted into a graphic sign. The release liner serves to protect the adhesive throughout the process and is removed, either by the printer or at the point of application, and in each case, becomes a waste. Release liners often end up in landfill because the release coating creates obstacles during recycling processes.

The present invention anticipates an innovative way of creating such laminate materials that eliminates the use of a release liner with a release coating on one or both sides, or without a release coating on either side.

The invention seeks to provide a laminate material in which the adhesive has a water-soluble protective coating that is easily removed and preferably may be recycled.

In one aspect comprised within claim 1, the present invention provides a method of producing a self-adhesive laminate material by providing a substrate having a first side and a second side, a print-receptive coating sandwiched between the substrate and a water-soluble coating on the first side and a pressure sensitive adhesive on the second side, and rolling up the material such that the water-soluble film comes into contact with and transfers to the adhesive to produce an adhesive-backed laminate material wherein the adhesive is protected by the water-soluble film.

The water-soluble film may be formed by coating the print receptive coating with an aqueous solution of water-soluble polymer which is dried to produce a film.

The substrate may have a print receptive coating and a water-soluble coating on the first side, may be rolled up, stored and unwound prior to coating with a pressure sensitive adhesive on the second side and rolled up a second time. The steps of rolling up and unwinding may be carried out at the same location or at different locations. When carried out at a different location, the rolled up material may become an article of commerce.

The dried water-soluble film comprises a thickness of less than 5 microns or more preferably a thickness of less than 3 microns.

The water-soluble film may comprise substantially polyvinyl alcohol.

The affinity of the pressure sensitive adhesive for the water-soluble film is greater than that of the water-soluble film for the print-receptive coating and transfer to the adhesive thereby occurs protecting the adhesive and preventing the product from blocking during storage in a roll.

The substrate may comprise any suitable material such as a paper or polymeric material. The water-soluble film may be based upon any suitable material such as a water-soluble or water-dispersible polymer. Suitable polymers include but are not limited to those based on poly-vinyl alcohol. The adhesive may comprise any suitable adhesive such as a pressure sensitive adhesive. Suitable pressure sensitive adhesives include but are not limited to a water-based pressure sensitive adhesive, a solvent-based pressure sensitive adhesive or a hotmelt pressure sensitive adhesive.

The water-soluble film may be formed by applying a coating of an aqueous solution or dispersion of the water-soluble polymer that, once dried, produces a film. The film may have a thickness of less than 5 microns, more preferably a thickness of less than 3 microns. By comparison, a typical release liner has a thickness greater than 19 microns, sometimes up to 140 microns in the case of graphic arts laminates. As a result, the reduced thickness of the water-soluble film of the present invention means that more material may be carried on a roll of given diameter which brings logistics and storage benefits.

The adhesive may be coated on the second side of the substrate either simultaneously, (i.e. at the same time as the water-soluble coating is applied to the first side), or sequentially (i.e. later) during the same pass, or in a separate pass. Where the adhesive and the water-soluble coating are applied during the same pass, this is known as dual coating.

The ability of any substrate to adhere inks, coatings, or adhesives is directly related to its surface energy. If the surface energy of the substrate does not significantly exceed the surface tension of the fluid which is to cover it, wetting will be impeded and a poor bond and/or pinholes could result. In order to ensure that water-soluble coatings of the present invention spread uniformly over the surface of the print-receptive coating, water-soluble coatings of increasing wetting tensions are applied to the print-receptive coating until a water-soluble coating is found that wets uniformly the surface of the print-receptive coating.

The term “surface energy,” or wetting, is used to describe the reactivity of the surface of a solid substrate, while “surface tension” is used in reference to a liquid. The phenomenon of surface energy is based on the relative energies of the solid substrate and the liquid in contact with it. Knowing the surface energy of a print-receptive coating is critical in assuring uniform “wetting” of the water-soluble coating of the present invention. Practical measurements of surface energy involve the interaction of the print-receptive coating with a water-soluble coating to determine wetting tension as a measure of surface energy. The surface energy of the print-receptive coating should be between 3 dynes/cm and 10 dynes/cm greater than the surface tension of the water-soluble coating in order to ensure acceptable performance. The water-soluble coatings of the present invention provide a surface tension of 40 to 50 dynes/cm, preferably 40 to 44 dynes/cm.

In the present invention, the thickness of the water-soluble coating after drying is only a few microns and hence the resulting water-soluble film cannot support itself. By casting the water-soluble coating upon a print-receptive coating coated upon a flat substrate, it is possible to create a water-soluble film of a few microns thickness which is supported by, and adheres to, the substrate until it enters into contact with the adhesive which occurs as the material is rolled up. The resulting bond between the adhesive and the water-soluble film is sufficient to remove the water-soluble film from the print-receptive coating, attaching itself to the adhesive thereby protecting the adhesive when the material is subsequently unrolled.

It is important to underline the difference in this application between the terms “water-soluble coating” and “water-soluble film” in order to avoid confusion. Once a water-soluble coating has been applied to a substrate and subsequently dried, it becomes a water-soluble film on the surface of the substrate. However, the term water-soluble film may also be used to describe a water-soluble substrate made from the water-soluble coating as can be illustrated by the water-soluble film which transfers from the print-ready coating to the adhesive as described above.

When a water-soluble coating is applied directly to an adhesive, it not only covers the peaks in the adhesive but also fills the troughs. In contrast, in the present invention, when the water-soluble film is produced by applying the water-soluble coating to a print-receptive coating coated upon a flat substrate and then dried, and subsequently transferred to protect the adhesive, it covers the peaks in the adhesive but does not fill the troughs. The importance of this distinction is two-fold: not only is less water-soluble polymer required to protect the adhesive thereby offering material savings, but its subsequent removal during activation of the adhesive will be facilitated as no water-soluble polymer will need to be removed from the troughs in the adhesive allowing a skimming or scraping tool to be more effectively employed.

The print-receptive coating is sandwiched between the substrate and the water-soluble film i.e. the water-soluble coating is applied on top of the print-receptive coating. The print-receptive coating may provide an enhanced key for the water-soluble film created when the water-soluble coating has dried. The print-receptive coating may comprise any suitable material designed to enhance the key of an ink or coating to the substrate. Suitable materials for the print-receptive coating include but are not limited to those based upon acrylic or urethane polymers.

Paper substrates are made from vegetable fibres and the surface of fibrous paper substrates may not be sufficiently smooth to receive print satisfactorily. A print-receptive coating provides a smooth surface to the fibrous paper substrate. Coatings can include those based upon calcium carbonate and china clay. In describing this feature, the terms “paper coating” and “coated paper” are taken to mean those paper coatings which are print-receptive.

Chemical additives may be added to the paper coating in order to provide additional benefits such as, but not limited to, thermochromic and/or anti-microbial properties.

Due to the inherent hydrophilic nature and porosity of paper fibres, hydrophobic polymeric materials, waxes, and inorganic fillers have been widely utilized as coatings and fillers, respectively, on paper substrates. Coatings also impart oxygen, aroma, and oil barrier properties desirable for food packaging applications. Coatings also improve the functional properties and characteristics of paper, including reduced water absorbency, enhanced surface finish, gloss finish, printability, readability, and dimensional stability.

Such functional properties are highly desirable for consumer packaging and labelling applications. However, such coatings may limit the repulpability, recyclability, biodegradability, and compostability of the paper substrate. In addition, the contamination of the paper substrate by-product also limits the recyclability of the fibre-based substrates, and the paper, paperboard, or corrugated material is likely to end up in landfill sites. Ending up in landfill sites is particularly likely where paper is being used to provide a label in which its lower surface has been coated with a pressure sensitive adhesive and in the case of self-wound linerless labels, its upper surface has been provided with a release coating so that when the linerless labels are wound into a roll, the roll does not block. The most widely used release coatings are those based upon silicones.

The water-soluble or water-dispersible coating can have a solid content between 15 and 30% with the remainder being substantially water. As previously explained, the water-soluble coating once dried and now present as a water-soluble substrate will be transferred to protect the pressure-sensitive adhesive on the lower surface of the paper when the coated paper substrate is rewound. It is therefore essential that the strength of the bond between the adhesive and the water-soluble substrate is greater than the bond between the water-soluble substrate and the coated surface of the paper. The latter bond will depend upon the penetration of the water-soluble coating into the coated surface of the paper.

Print-receptive coatings are designed to enhance the adhesion of print to the substrate and it could be expected that the same enhancement would occur between the water-soluble film and the print-receptive coating but we have found that this is not the case with certain water-soluble polymers including those based upon poly-vinyl alcohol. We have found that not only are such water-soluble films easily removable from the print-receptive coating but no traces of the water-soluble film remain on the upper surface of the print-receptive coating to interfere with subsequent printing.

When the laminate material of the present invention is unwound at a printer or a label applicator or for use in graphic arts, the water-soluble film is no longer present on the first side of the substrate leaving the first side of the substrate free of any residual contamination by the water-soluble film so that the first side remains ready to receive inks or decorative coatings.

The water-soluble film can be removed from the adhesive prior to applying the laminate material to an object by applying water as a spray or mist to the surface of the water-soluble film in order to soften the water-soluble film and then by rubbing the softened film to facilitate the removal of the now at least partially solubilised film from the surface of the adhesive. The laminate material, now with an exposed adhesive, can be cut and applied to an object. After removal, the solubilised water-soluble film may present as a gel that can be readily recycled.

The substrate may comprise any suitable material such as paper of any thickness of at least 50 gsm or a polymeric material such as a substrate of thickness typically between 13 and 100 microns made for example from polypropylene, polyester, polyethylene, or poly-vinyl chloride.

The water-soluble film may comprise any suitable material such as those films based substantially upon poly-vinyl alcohol polymers.

The adhesive may comprise any suitable adhesive such as a water-based pressure sensitive adhesive, a solvent-based pressure sensitive adhesive or a hotmelt pressure sensitive adhesive.

The substrate may include a print-receptive coating on the first side and an adhesive-receptive coating on the second side.

The water-soluble film may have a thickness of less than 5 microns, more preferably a thickness of less than 3 microns.

The adhesive may be coated on the second side of the substrate either simultaneously (i.e. at the same time) as the water-soluble coating is applied to the first side, or sequentially (i.e. later) during the same pass or in a separate pass. Where the adhesive and the water-soluble coating are applied during the same pass, this is known as dual coating.

In a further aspect comprised within claim 7, the present invention provides a self-adhesive laminate material comprising a substrate having a first side and a second side, a print-receptive coating on a first side of the substrate and a water-soluble coating upon the print receptive coating such that when a pressure-sensitive adhesive is applied to the second side and the material wound into a roll, the adhesion of the water-soluble coating to the print-receptive coating on the first side is less than the adhesion provided by the adhesive to the water-soluble coating causing the water-soluble coating to transfer to the adhesive thereby protecting the adhesive.

Where the self-adhesive laminate material is provided in roll form, the adhesion of the water-soluble film to the pressure sensitive adhesive is greater than the adhesion of the water-soluble film to the print-receptive coating such that when the material is unwound, the water-soluble film remains attached to the pressure sensitive adhesive.

Self-adhesive graphic signs and self-adhesive labels may be produced from the material by solubilisation at least in part of the water-soluble coating, thereby activating the adhesive.

The print receptive coating comprises a material designed to enhance the key of an ink or coating to the substrate.

The substrate may have a print-receptive coating on the first side and an adhesive-receptive coating on the second side.

The substrate may be polymeric or paper or a combination thereof.

The print surface of the print-receptive coating is uncontaminated by traces of water-soluble film after the transfer of the water-soluble film such that subsequent print processes are unaffected.

The dry weight of water-soluble film required to protect the adhesive without blocking is less that than that required for direct coating of a water-soluble coating upon the adhesive without blocking.

The water-soluble film comprises a thickness less than 5 microns, or more preferably a thickness of less than 3 microns.

The water-soluble film comprises substantially poly-vinyl alcohol.

The adhesive has a surface with peaks and troughs and the water-soluble film comes into contact with the peaks and does not fill the troughs.

The surface of the print-receptive coating providing an enhanced key is uncontaminated by traces of the water-soluble film after its transfer to the adhesive.

The dry weight of water-soluble coating required to protect the adhesive without blocking may be less than that required for direct coating without blocking.

The self-adhesive laminate may be produced in two operations. In a first operation, a laminate material may be produced comprising a substrate, a coating of print-receptive material upon a first side of a substrate and a water-soluble film upon the print-receptive coating. The water-soluble coating may be applied in the form of an aqueous solution or dispersion of a water-soluble polymer, for example by known coating techniques, and dried before the resulting material is rolled up. In a second operation, the material is unwound and an adhesive applied upon a second side of the substrate. The second side of the substrate may have received an adhesive-receptive coating before the adhesive is applied. The first and second operations may be carried out at different locations.

The resulting self-adhesive laminate thus comprises an adhesive on the second side of the material such that when the laminate material is rolled up after the second operation, the water-soluble film on the first side is transferred to the adhesive on the second side such that the water-soluble film protects the adhesive.

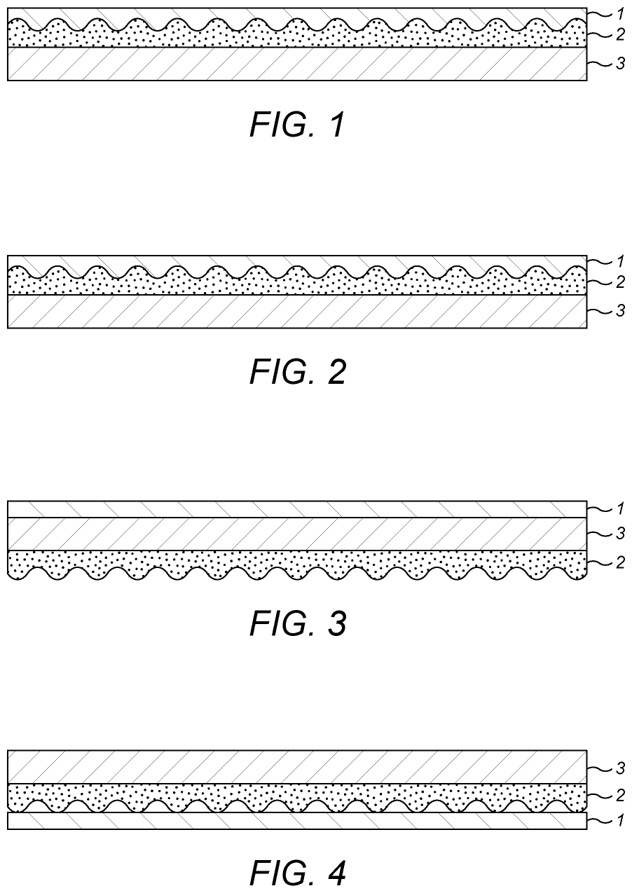

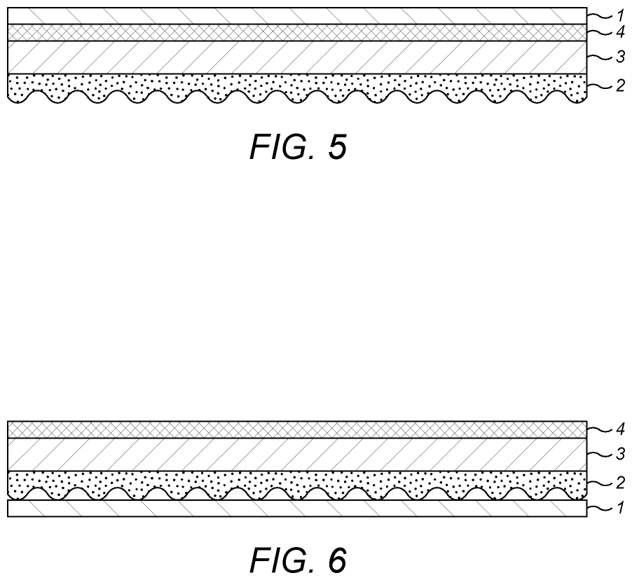

By way of illustration of the present invention only, FIGS. 1 thru 6 are shown. In all six figures, a polymeric or paper substrate is marked (3), a pressure sensitive adhesive is marked (2) and a water-soluble protective film is marked (1). In FIGS. 5 and 6, a print-receptive coating is marked (4).

FIGS. 1 and 2 illustrate a product not according to the invention. In FIG. 1, the water-soluble film 1 is created by direct application of a water-soluble coating upon a pressure-sensitive adhesive (2) which has previously been coated upon one side of the polymeric or paper substrate (3). The water-soluble coating is applied as an aqueous solution or dispersion of a water-soluble polymer such as polyvinyl alcohol and dried to form the film 1. As can be seen, the water-soluble coating covers the peaks and fills the troughs created by irregularities in the surface of the adhesive.

FIG. 2 illustrates the product of FIG. 1 after it has been rolled up and unwound. No change has occurred to the product i.e. the film 1 remains attached to the adhesive.

FIGS. 3 and 4 illustrate an embodiment of a product according to the invention. In FIG. 3, the water-soluble coating forming the film 1 is applied as an aqueous solution or dispersion of water-soluble polymer upon an upper face of the polymeric or paper substrate (3) and dried to form the film 1. A pressure sensitive adhesive (2) is applied to the lower face of the polymeric or paper substrate either in the same pass or in a separate pass.

FIG. 4 illustrates the product of FIG. 3 after it has been rolled up and unwound. As shown, the water-soluble film (1) has transferred from the substrate (3) to the adhesive (2) which as a result, is now protected from blocking in the roll. As can be seen, the film attaches to the peaks but does not fill the troughs created by irregularities in the surface of the adhesive.

FIGS. 5 and 6 illustrate another embodiment of a product according to the invention. In FIG. 5, the water-soluble coating forming the film (1) is applied as an aqueous solution or dispersion of water-soluble polymer upon an upper face of the polymeric or paper substrate (3) which has already been coated with the print-receptive coating (4) and dried to form the film (1) with the print-receptive coating (4) sandwiched between the substrate (3) and film (1). A pressure sensitive adhesive (2) is applied to the lower face of the polymeric or paper substrate.

FIG. 6 illustrates the product of FIG. 5 after it has been rolled up and unwound. The water-soluble film (1) has transferred from the print-receptive coating (4) to the pressure sensitive adhesive (2) which as a result, is now protected from blocking in the roll. As can be seen, the film (1) attaches to the peaks but does not fill the troughs created by the irregularities in the surface of the adhesive.

As will be apparent from the foregoing, the present invention provides a laminate material and a method by which the laminate can be produced and processed into an adhesive label or graphic sign without the use of a release liner during its manufacture and without creating the need to dispose of a release liner following application of a label or graphic sign.

In addition, by forming the water-soluble film on the opposite side of the substrate to which the adhesive is applied and subsequently transferring the film to the adhesive, the water-soluble material of the film only adheres to the peaks and does not fill the troughs created by irregularities in the surface of the adhesive. As a result, the thickness of the water-soluble film may be reduced, in turn reducing the amount of water-soluble material used to form the water-soluble film and thereby facilitating subsequent removal of the film to expose the adhesive for attaching the product to the surface of an object.

Moreover, the present invention provides an adhesive laminate and a means of manufacturing an adhesive laminate without the use of a release liner wherein the pressure sensitive adhesive is protected by a water-soluble film having such a reduced thickness that it is unable to support itself.

1. A method of producing a self-adhesive laminate material comprising a substrate having a first side and a second side, a print receptive coating sandwiched between the substrate and a water-soluble coating on the first side and a pressure sensitive adhesive on the second side, the method comprising the steps of:
applying the water-soluble coating to the print receptive coating;
drying the water-soluble coating to produce a water-soluble film;
applying the pressure sensitive adhesive to the second side of the substrate; and,
rolling up the material such that the water-soluble film comes into contact with and transfers to the pressure sensitive adhesive to produce an adhesive-backed laminate material wherein the adhesive is protected by the water-soluble film.

2. The method according to claim 1 wherein the water-soluble coating is an aqueous solution of water-soluble polymer.

3. The method according to claim 1 wherein the method further includes an additional first step of rolling up and storing the substrate having the print receptive coating and the water-soluble film on the first side, a second step of unwinding the substrate for to coating with a pressure sensitive adhesive on the second side and rolled a third step of rolling up the material a second time after coating with the pressure sensitive adhesive such that the water-soluble film comes into contact with and transfers to the pressure sensitive adhesive to produce an adhesive-backed laminate material wherein the adhesive is protected by the water-soluble film.

4. The method according to claim 2 wherein the dried water-soluble film comprises a thickness of less than 5 microns.

5. The method according to claim 2 wherein the dried water-soluble film comprises a thickness of less than 3 microns.

6. The method according to claim 2 wherein the water-soluble film comprises polyvinyl alcohol.

7. (canceled).

8. (canceled).

9. (canceled).

10. (canceled).

11. (canceled).

12. (canceled).

13. (canceled).

14. (canceled).

15. (canceled).

16. (canceled).

17. (canceled).

18. (canceled).

19. A laminate material comprising:
a substrate having a first side and a second side;
a print receptive coating applied to the first side of the substrate;
a water-soluble coating applied to the print receptive coating, wherein the water-soluble coating is dried to create a water-soluble film; and,
wherein the second side of the substrate is configured for receiving a pressure-sensitive adhesive.

20. The laminate material of claim 19, wherein the pressure-sensitive adhesive is applied to the second side of the substrate and the material is rolled up such that the water-soluble film contacts with and transfers to the pressure sensitive adhesive wherein the pressure-sensitive adhesive is protected by the water-soluble film.

21. The laminate material according to claim 20 wherein adhesion of the water-soluble film to the pressure sensitive adhesive is greater than adhesion of the water-soluble film to the print receptive coating wherein when the material is unwound, the water-soluble film remains attached to the pressure sensitive adhesive.

22. The laminate material according to claim 20 wherein the pressure sensitive adhesive is activated by solubilization of a portion of the water-soluble film.

23. The laminate material according to claim 20 wherein the print receptive coating comprises a material to enhance adhesion of an ink or coating to the substrate.

24. The laminate material according to claim 19 wherein the substrate is a polymer or a paper or a combination thereof.

25. The laminate material according to claim 20 wherein the water-soluble film comprises a thickness less than 5 microns.

26. The laminate material according to claim 20 wherein the water-soluble film comprises a thickness less than 3 microns.

27. The laminate material according to claim 20 wherein the water-soluble film comprises poly-vinyl alcohol.

28. The laminate material according to claim 19 wherein the adhesive has a surface with peaks and troughs and the water-soluble film comes into contact only with the peaks.
